(19) United States
(12) Patent Application Publication
(10) Pub. No.: US 2026/0142083 A1
(43) Pub. Date: May 21, 2026

(54) MULTILAYER CERAMIC ELECTRONIC DEVICE

(71) Applicant: TAIYO YUDEN CO., LTD., Tokyo (JP)

(72) Inventor: Koichiro MORITA, Takasaki-shi (JP)

(21) Appl. No.: 19/367,152

(22) Filed: Oct. 23, 2025

(30) Foreign Application Priority Data
Nov. 11, 2024 (JP) 2024-196718

(51) Int. Cl. H01G 4/12; H01G 4/224; H01G 4/232; H01G 4/248; H01G 4/30

(52) U.S. Cl. CPC H01G 4/1227; H01G 4/224; H01G 4/232; H01G 4/248; H01G 4/30

(57) ABSTRACT

A multilayer ceramic electronic device includes a dielectric layer, internal electrode layers, a cover layer, a side margin, and an external electrode. At least a section of an outer periphery consisting of the cover layer and the side margin contains barium titanate as a main component, and when an amount of titanium of the barium titanate is taken as 100 mol %, the section contains 0.1 mol % or more of boron, 1.0 mol % or more of silicon, and 1.0 mol % or more of aluminum, with less than 0.1 mol % of magnesium and less than 0.1 mol % of manganese, and an aluminum concentration of the section is equal to or greater than that of the dielectric layer.

### CROSS-REFERENCE TO RELATED APPLICATION

This application is based upon and claims the benefit of priority of the prior Japanese Patent Application No. 2024-196718, filed on Nov. 11, 2024, the entire contents of which are incorporated herein by reference.

### FIELD

A certain aspect of the present disclosure relates to a multilayer ceramic electronic device.

### BACKGROUND

In high-frequency communication systems, such as mobile phones, multilayer ceramic electronic components such as multilayer ceramic capacitors (MLCCs) are used to eliminate noise (see, for example, Japanese Patent Application Publication No. 2018-182128, Japanese Patent Application Publication No. 2020-113575, Japanese Patent Application Publication No. 2009-16796, Japanese Patent Application Publication No. 2020-202402, and Japanese Patent Application Publication No. 2024-43312).

### SUMMARY OF THE INVENTION

According to an aspect of the embodiments, there is provided a multilayer ceramic electronic device including: a dielectric layer; internal electrode layers facing each other with the dielectric layer therebetween; a cover layer provided outside an outermost one of the internal electrode layers in a first direction which is a stacking direction of the dielectric layer and the internal electrode layers; a side margin provided adjacent to the dielectric layer and the internal electrode layers in a second direction orthogonal to the first direction; and an external electrode provided adjacent to the internal electrode layers in a third direction orthogonal to the first direction and the second direction and electrically connected to the internal electrode layers, wherein at least a section of an outer periphery consisting of the cover layer and the side margin contains barium titanate as a main component, and when an amount of titanium of the barium titanate is taken as 100 mol %, the section contains 0.1 mol % or more of boron, 1.0 mol % or more of silicon, and 1.0 mol % or more of aluminum, with less than 0.1 mol % of magnesium and less than 0.1 mol % of manganese, and an aluminum concentration of the section is equal to or greater than that of the dielectric layer.

### BRIEF DESCRIPTION OF THE DRAWINGS

FIG. 1 is a partial cross-sectional perspective view of a multilayer ceramic capacitor;

FIG. 2 is a cross-sectional view taken along line A-A in FIG. 1;

FIG. 3 is a cross-sectional view taken along line B-B in FIG. 1;

FIG. 4A and FIG. 4B are enlarged cross-sectional views of vicinity of external electrodes;

FIG. 5A to FIG. 5D are diagrams explaining an outer periphery;

FIG. 6A and FIG. 6B illustrate a backscattered electron image taken with an SEM of a portion of a cross section of an outer periphery, which is primarily composed of barium titanate;

FIG. 7A and FIG. 7B are diagrams illustrating borosilicate glass;

FIG. 8 illustrates a flow of a manufacturing method of a multilayer ceramic capacitor;

FIG. 9A and FIG. 9B illustrate a printing process; and

FIG. 10 illustrates a crimping process.

### DESCRIPTION OF EMBODIMENTS

In multilayer ceramic electronic devices, differences in the sintering state may occur between the outer periphery surrounding the capacity section and the dielectric layer of the capacity section, which may reduce moisture resistance. Attempting to improve moisture resistance, however, may adversely affect the electrical characteristics of the capacity section.

Hereinafter, an exemplary embodiment will be described with reference to the accompanying drawings.

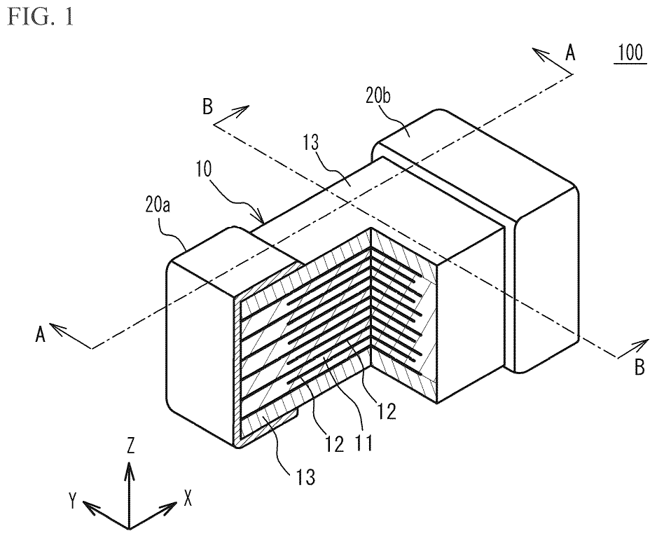

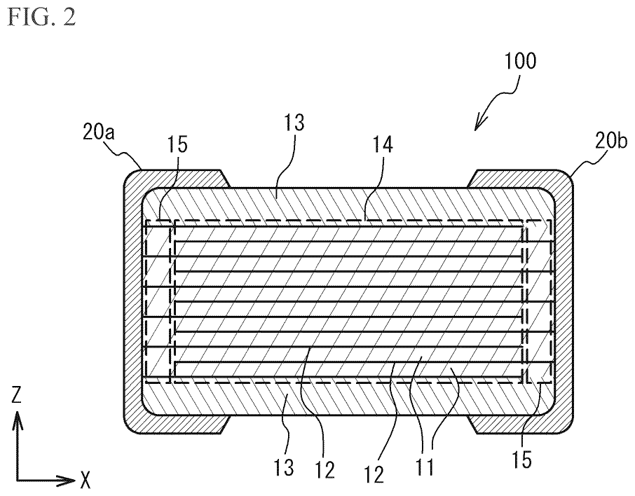

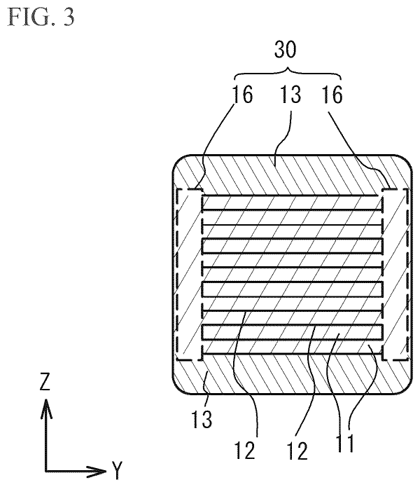

(Embodiment) FIG. 1 illustrates a perspective view of a multilayer ceramic capacitor 100, in which a cross section of a part of the multilayer ceramic capacitor 100 is illustrated. FIG. 2 is a cross-sectional view taken along line A-A in FIG. 1. FIG. 3 is a cross-sectional view taken along line B-B in FIG. 1. As illustrated in FIG. 1 to FIG. 3, the multilayer ceramic capacitor 100 includes a multilayer chip 10 having a rectangular parallelepiped shape, and external electrodes 20a and 20b that are respectively provided on two end faces of the multilayer chip 10 facing each other. Among four faces other than the two end faces of the multilayer chip 10, two faces other than the upper face and the lower face in the stacking direction are referred to as side faces. Each of the external electrodes 20a and 20b extends to the upper face and the lower face in the stacking direction and the two side faces of the multilayer chip 10. However, the external electrodes 20a and 20b are spaced from each other.

In FIG. 1 to FIG. 3, a Z-axis direction (first direction) is the stacking direction. The Z-axis direction is a direction in which internal electrode layers face each other. An X-axis direction (second direction) is a longitudinal direction of the multilayer chip 10. The X-axis direction is a direction in which the two end faces of the multilayer chip 10 are opposite to each other and in which the external electrode 20a is opposite to the external electrode 20b. A Y-axis direction (third direction) is a width direction of the internal electrode layers. The Y-axis direction is a direction in which the two side faces of the multilayer chip 10 are opposite to each other. The X-axis direction, the Y-axis direction and the Z-axis direction are vertical to each other.

The element body 10 has a structure designed to have dielectric layers 11 and internal electrode layers 12 alternately stacked. The dielectric layer 11 contains a ceramic material acting as a dielectric material. End edges of the internal electrode layers 12 are alternately exposed to a first end face of the multilayer chip 10 and a second end face of the multilayer chip 10 that is different from the first end face. The external electrode 20a is provided on the first end face. The external electrode 20b is provided on the second end face. Thus, the internal electrode layers 12 are alternately electrically connected to the external electrode 20a and the external electrode 20b. Accordingly, the multilayer ceramic capacitor 100 has a structure in which a plurality of the dielectric layers 11 are stacked with the internal electrode layers 12 interposed therebetween. In the multilayer structure of the dielectric layers 11 and the internal electrode layers 12, the outermost layers in the stack direction are the internal electrode layers 12, and cover layers 13 cover the top face and the bottom face of the multilayer structure. The cover layer 13 is mainly composed of a ceramic material. For example, the main component of the cover layer 13 may be the same as the main component of the dielectric layer 11 or may be different from the main component of the dielectric layer 11. Note that the configuration is not limited to those illustrated in FIG. 1 to FIG. 3, as long as the internal electrode layers 12 are exposed on two different surfaces and are electrically connected to different external electrodes.

For example, the multilayer ceramic capacitor 100 may have a length of 0.25 mm, a width of 0.125 mm, and a height of 0.125 mm. The multilayer ceramic capacitor 100 may have a length of 0.4 mm, a width of 0.2 mm, and a height of 0.2 mm. The multilayer ceramic capacitor 100 may have a length of 0.6 mm, a width of 0.3 mm, and a height of 0.3 mm. The multilayer ceramic capacitor 100 may have a length of 1.0 mm, a width of 0.5 mm, and a height of 0.5 mm. The multilayer ceramic capacitor 100 may have a length of 3.2 mm, a width of 1.6 mm, and a height of 1.6 mm. The multilayer ceramic capacitor 100 may have a length of 4.5 mm, a width of 3.2 mm, and a height of 2.5 mm. However, the size of the multilayer ceramic capacitor 100 is not limited to the above sizes.

The main component of the internal electrode layer 12 is not particularly limited, but is a base metal such as Ni (nickel), Cu (copper), Sn (tin). As a main component of the internal electrode layers 12, noble metals such as Pt (platinum), Pd (palladium), Ag (silver), Au (gold), and alloys containing these may be used. The internal electrode layer 12 may include a ceramic grain such as a co-material. The thickness of the internal electrode layers 12 is, for example, 5.0 μm or less, 3.0 μm or less, or 1.0 μm or less. The thickness of the internal electrode layers 12 can be measured by observing a cross section of the multilayer ceramic capacitor 100 with a scanning electron microscope (SEM), measuring the thickness at 10 points for each of 10 different internal electrode layers 12, and deriving the average value of all the measurement points.

A main component of the dielectric layer 11 is a ceramic material having a perovskite structure expressed by a general formula ABO₃. The perovskite structure includes ABO_{3-α} having an off-stoichiometric composition. For example, the ceramic material is such as BaTiO₃ (barium titanate). For example, the dielectric layers 11 contain 90 at % or more of the main component ceramic. The thickness of the dielectric layers 11 is, for example, 5.0 μm or less, 3.0 μm or less, or 1.0 μm or less. The thickness of the dielectric layers 11 can be measured by observing a cross section of the multilayer ceramic capacitor 100 with a scanning electron microscope (SEM), measuring the thickness at 10 points for each of 10 different dielectric layers 11, and deriving the average value of all the measurement points.

Additives may be added to the dielectric layer 11. As additives to the dielectric layer 11, zirconium (Zr), hafnium (Hf), magnesium (Mg), manganese (Mn), molybdenum (Mo), vanadium (V), chromium (Cr), rare earth elements (yttrium (Y), samarium (Sm), europium (Eu), gadolinium (Gd), terbium (Tb), dysprosium (Dy), holmium (Ho), erbium (Er), thulium (Tm), and ytterbium (Yb)) or an oxide of cobalt (Co), nickel (Ni), lithium (Li), boron (B), sodium (Na), potassium (K) or silicon (Si), or a glass including cobalt, nickel, lithium, boron, sodium, potassium or silicon.

As illustrated in FIG. 2, the section where the internal electrode layers 12 connected to the external electrode 20a faces the internal electrode layers 12 connected to the external electrode 20b is a section where capacity is generated in the multilayer ceramic capacitor 100. Thus, this section is referred to as a capacity section 14. That is, the capacity section 14 is a section where two adjacent internal electrode layers 12 connected to different external electrodes face each other.

The section where the internal electrode layers 12 connected to the external electrode 20a face each other with no internal electrode layer 12 connected to the external electrode 20b interposed therebetween is referred to as an end margin 15. The section where the internal electrode layers 12 connected to the external electrode 20b face each other with no internal electrode layer 12 connected to the external electrode 20a interposed therebetween is also the end margin 15. That is, the end margin 15 is a section where the internal electrode layers 12 connected to one of the external electrodes face each other with no internal electrode layer 12 connected to the other of the external electrodes interposed therebetween. The end margin 15 is a section where no capacity is generated.

As illustrated in FIG. 3, in the multilayer chip 10, a side margin 16 is a section provided so as to cover the ends (ends in the Y-axis direction) of the two side faces of the dielectric layers 11 and the internal electrode layers 12. That is, the side margin 16 is a section provided outside the capacity section 14 in the Y-axis direction. The side margin 16 is also a section where no capacity is generated.

In the YZ cross section, the cover layer s13 and the side margins 16 form the outer periphery surrounding the capacity section 14. Therefore, hereinafter, the portion forming the outer periphery surrounding the capacity section 14 in the YZ cross section may be collectively referred to as an outer periphery 30. Note that the cover layer 13 refers to the portion of the outer periphery 30 in the YZ cross section that is above the uppermost internal electrode layer 12 in the Y-axis direction. Therefore, the capacity section 14 and the pair of side margins are sandwiched between the two cover layers 13.

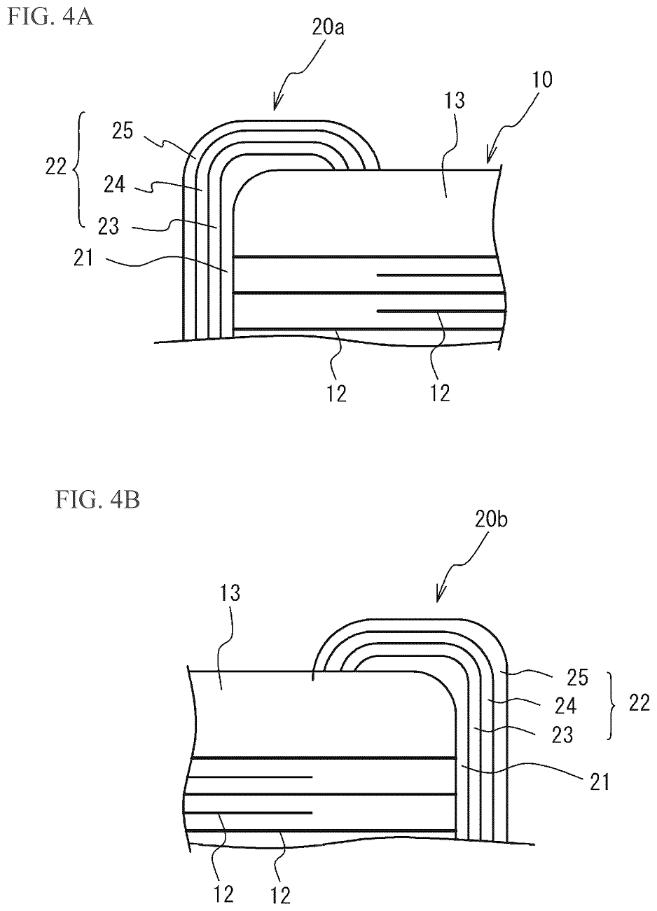

FIG. 4A is an enlarged cross-sectional view of the vicinity of the external electrode 20a. FIG. 4B is an enlarged cross-sectional view of the vicinity of the external electrode 20b. In FIG. 4A and FIG. 4B, hatches are omitted. As illustrated in FIG. 4A and FIG. 4B, the external electrodes 20a and 20b have a structure in which a plated layer 22 is provided on a base layer 21. The base layer 21 is primarily composed of nickel, copper, or the like. The base layer 21 may contain a ceramic grain or a glass component as a co-material. The plated layer 22 is primarily composed of a metal such as nickel, copper, aluminum, zinc, or tin, or an alloy of two or more of these metals. The plated layer 22 may be a plated layer of a single metal component or multiple plated layers of different metal components. For example, the plated layer 22 has a structure in which a first plated layer 23, a second plated layer 24, and a third plated layer 25 are formed in this order from the base layer 21 side. The first plated layer 23 is, for example, a copper plated layer. The second plated layer 24 is, for example, a nickel plated layer. The third plated layer 25 is, for example, a tin plated layer.

Here, the sintering delay in multilayer ceramic capacitors will be described. During firing, metal elements (for example, nickel, copper, or the like) that are components of the internal electrode layers in the capacity section diffuse into the dielectric layers, accelerating sintering. However, this mechanism does not affect the dielectric in the outer periphery, which does not contain the internal electrode layers. Therefore, during firing, the problem arises that sintering is delayed in the outer periphery compared to the capacity section. For this reason, if the capacity section is fired at a temperature that properly sinters and densifies it, the outer periphery will not be sufficiently densified, making it more susceptible to moisture penetration from the outside and reducing the moisture resistance of the multilayer ceramic capacitor. On the other hand, if the outer periphery is fired to a level that ensures sufficient moisture resistance, the capacity section may be oversintered, resulting in dielectric grain growth and discontinuities in the internal electrode layers, shortening the capacitor's lifespan and potentially adversely affecting the capacitor's electrical characteristics.

Usually, firing conditions are set to strike a balance between moisture resistance and electrical characteristics, while still addressing this trade-off issue. However, this is not the optimal sintering condition for both the outer periphery and the capacity section, and mass production can result in defective products whose moisture resistance and electrical characteristics do not meet specified values. To produce multilayer ceramic capacitors for applications requiring extremely high reliability, such as automotive multilayer ceramic capacitors, fundamental solutions are needed rather than seeking a compromise between the sinterability of the outer periphery and the capacity section.

One possible approach to promote sintering of the outer periphery is to increase the amount of silicon and boron, sintering aid glass components that promote sintering. However, this approach risks causing grain growth in the dielectric layer of the capacity section, thereby reducing lifespan of the dielectric layer. Therefore, a method is needed to retain boron and silicon in the outer periphery.

Next, a possible approach is to use nickel-solid-dissolved barium titanate powder as the main phase of the outer periphery instead of pure barium titanate. This approach focuses on the fact that the sinterability of the capacity section is due to the diffusion of nickel in the internal electrode layers, and applies this effect to the outer periphery as well, aiming to eliminate the difference between the inside and outside of the sintering. Furthermore, this approach is advantageous in that it does not simply supply nickel in the form of nickel metal powder or nickel oxide, which precipitates as a metal on the surface of the multilayer ceramic capacitor after firing in a reducing atmosphere. This is because nickel appearing as a metal on the surface of the multilayer ceramic capacitor is undesirable, as it can cause plating elongation and soldering defects. However, this approach can also present a problem. When nickel-solid-dissolved barium titanate is used, the density of the outer periphery increases too much, resulting in increased internal stress. While this may not be a problem for very small multilayer ceramic capacitors, relatively large multilayer ceramic capacitors such as those used in automotive applications are prone to cracking. In the first place, nickel diffusion from the electrode in the capacity section does not solid-dissolve nickel throughout the barium titanate grains, but rather primarily in the grain boundaries and the portions near the grain surfaces (shell portions) adjacent to the grain boundaries. Therefore, incorporating nickel into the main phase in the outer periphery would not achieve the same state as in the capacity section. It is known that other metal elements improve sinterability when solid-dissolved in barium titanate, and methods for adding these metal elements to the outer periphery are known. One example is the addition of large amounts of magnesium or manganese to the outer periphery.

For example, one possible simple method is to incorporate a large amount of magnesium, an element that promotes sintering of barium titanate, into the outer periphery. While this method is effective due to its simplicity, magnesium diffusion from the outer periphery to the capacity section by concentration diffusion can lower the dielectric constant of the capacity section, and excessive magnesium solid-dissolving in barium titanate as an acceptor can increase oxide ion defects and reduce lifespan.

Next, instead of simply adding “sintering aid components” such as magnesium and manganese to the outer periphery to promote sintering, creating a region between the outer periphery and the capacity section where the concentration of the sintering aid components is low could be considered to suppress the unidirectional diffusion of magnesium and manganese from the outer periphery to the capacity section. While this is certainly a very effective method for eliminating the internal/external differences in sintering, it requires the creation of a complex dual structure to prevent internal diffusion of the sintering aid, which is time-consuming and costly. Therefore, a simpler method that achieves a similar effect is needed.

So, one possible approach would be to combine a method in which at least one of magnesium, nickel, manganese, aluminum, and chromium is contained in both the outer periphery and the capacity section, with the outer periphery having a higher concentration, with the outer periphery having an A-rich A/B ratio (the ratio of A-site elements to B-site elements in perovskite crystals). This may suppress cracking. However, this method does not prevent the diffusion of magnesium and manganese into the capacity section as mentioned above, and A-rich refers to Ba-rich in barium titanate. Like magnesium and manganese, diffusing barium from the high-concentration outer periphery into the capacity section is a simple method for lowering the dielectric constant of the capacity section, but it does not provide an essential solution.

As a result of extensive research, the inventor has discovered that by adding aluminum to the outer periphery 30 in addition to boron and silicon, the boron and silicon can be retained in the outer periphery 30, and the sintered state of the capacity section 14 can be matched to the sintered state of the outer periphery 30.

As a result of further intensive research, the inventor has discovered that at least a portion of the outer periphery 30 contains barium titanate as the main component, and when the titanium content of the barium titanate is taken as 100 mol %, the outer periphery 30 contains 0.1 mol % or more of boron, 1.0 mol % or more of silicon, and 1.0 mol % or more of aluminum, with less than 0.1 mol % magnesium and less than 0.1 mol % manganese, and an aluminum concentration equal to or greater than the aluminum concentration in the dielectric layer 11 of the capacity section 14, eliminating the difference in sintering rate between the outer periphery 30 and the capacity section 14, thereby improving moisture resistance, while suppressing adverse effects on the electrical characteristics of the capacity section 14.

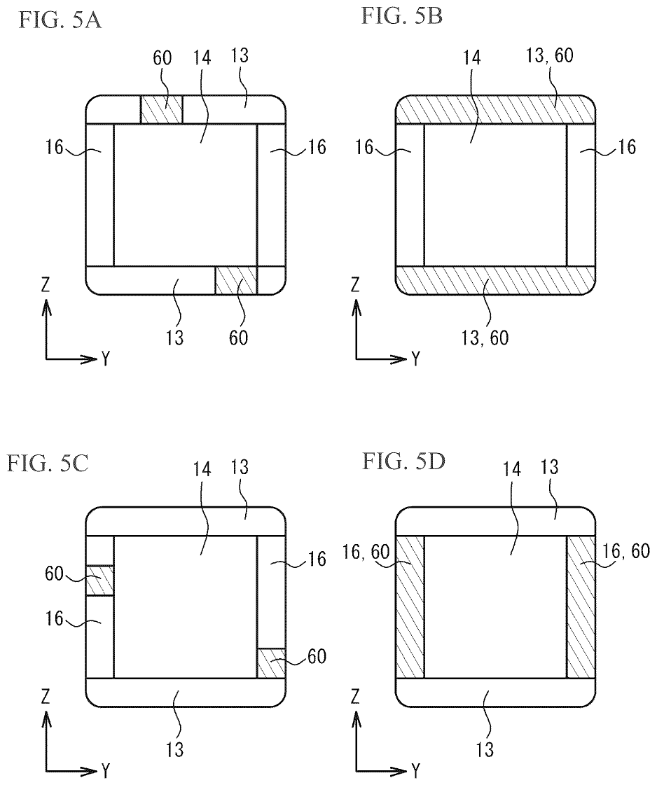

This at least a portion of the outer periphery 30 is referred to as a section 60. The section 60 may be a portion of the cover layer 13, as illustrated in FIG. 5A. Alternatively, the section 60 may be the entire cover layer 13, as illustrated in FIG. 5B. Alternatively, the section 60 may be a portion of the side margin 16, as illustrated in FIG. 5C. Alternatively, the section 60 may be the entire side margin 16, as illustrated in FIG. 5D.

First, by setting the amount of magnesium and manganese in the section 60 to less than 0.1 mol %, the amount of magnesium and manganese is sufficiently reduced, thereby suppressing the adverse effects of magnesium and manganese diffusion from the section 60 on the electrical characteristics of capacity section 14.

Next, by setting the amount of boron in the section 60 to 0.1 mol % or more, the amount of silicon in the section 60 to 1.0 mol % or more, and the amount of aluminum in the section 60 to 1.0 mol % or more, borosilicate glass containing aluminum can be obtained, for example. This aluminum-containing borosilicate glass not only promotes sintering of the section 60, which is primarily composed of barium titanate, but also tends to remain without being expelled from grain boundaries and gaps between grains known as triple junctions. Furthermore, by maintaining the aluminum concentration in the section 60 equal to or higher than that in the dielectric layer 11 of the capacity section 14, the glass component tends to remain in the section 60. The aluminum concentration in the dielectric layer 11 of the capacity section 14 refers to the mol % of aluminum when the titanium content of barium titanate, the main component of the dielectric layer 11, is 100 mol %.

As a result, the multilayer ceramic capacitor 100 according to this embodiment eliminates the difference in sintering rate between the section 60 and the capacity section 14, improving moisture resistance while suppressing adverse effects on the electrical characteristics of the capacity section 14. This enables a higher level of both moisture resistance and electrical characteristics to be achieved than multilayer ceramic capacitors previously fabricated by sintering the outer periphery and the capacity section at a compromise point. As a result, a multilayer ceramic capacitor more suitable for applications requiring extremely high reliability, such as automotive applications, can be realized.

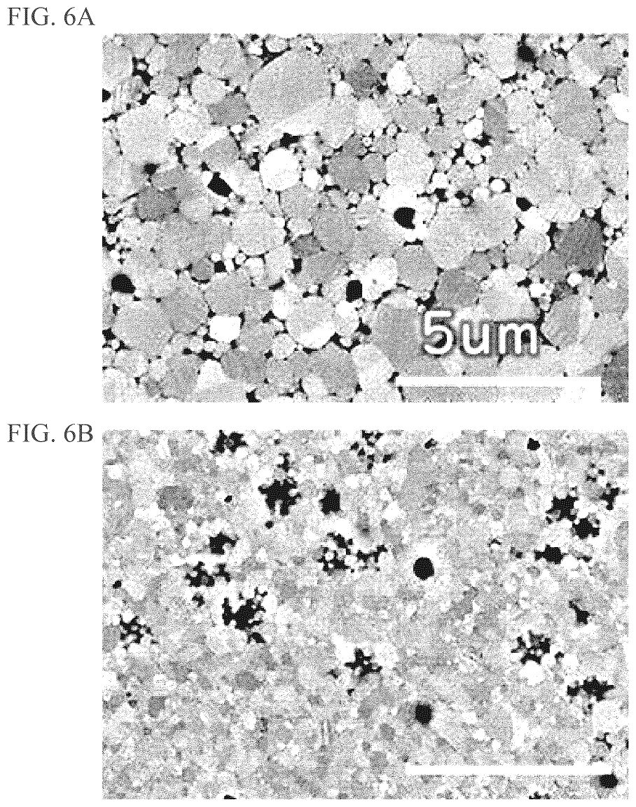

FIG. 6A and FIG. 6B are backscattered electron images taken with an SEM of portions of the cross section of the outer periphery, primarily composed of barium titanate. FIG. 6A is a backscattered electron image obtained when the titanium content is 100 mol %, the boron content is 0.1 mol % or more, the silicon content is 1.0 mol % or more, and the aluminum content is 1.0 mol % or more. As illustrated in FIG. 6A, a dark phase (a light element representing a glass phase) is present between and in the gaps between grains, wetting the entire grain well.

In contrast, FIG. 6B is a backscattered electron image obtained when the titanium content is 100 mol %, the boron content is 0.1 mol % or more, the silicon content is 1.0 mol % or more, but no aluminum is added. As illustrated in FIG. 6B, scattered segregated grains formed by the expulsion of the glass phase from the grain boundaries can clearly be seen.

To fully utilize the effect of boron as a sintering aid, the higher the boron content in the section 60, the better. In this embodiment, when the titanium content of barium titanate in the section 60 is 100 mol %, the boron content in the section 60 is preferably 0.5 mol % or more, and more preferably 1.0 mol % or more.

On the other hand, if the boron content is too high, it may affect the appearance of the multilayer ceramic capacitor 100. Therefore, it is preferable to set an upper limit on the boron content in the section 60. In this embodiment, when the titanium content of barium titanate in the section 60 is 100 mol %, the boron content is preferably 2.5 mol % or less, more preferably 2.0 mol % or less, and even more preferably 1.5 mol % or less.

Next, to fully utilize the effect of silicon as a sintering aid, the higher the silicon content in the section 60, the better. In this embodiment, in the section 60, when the titanium content of barium titanate is 100 mol %, the silicon content is preferably 1.5 mol % or more, and more preferably 2.0 mol % or more.

On the other hand, if the silicon content is too high, it may affect the appearance of the multilayer ceramic capacitor 100. Therefore, it is preferable to set an upper limit on the silicon content in the section 60. In this embodiment, when the titanium content of barium titanate in the section 60 is 100 mol %, the silicon content is preferably 3.0 mol % or less, more preferably 2.7 mol % or less, and even more preferably 2.5 mol % or less.

Next, in order to retain sufficient amounts of boron and silicon in the section 60, the higher the aluminum content in the section 60, the better. In this embodiment, when the titanium content of barium titanate in the section 60 is 100 mol %, the aluminum content is preferably 2.0 mol % or more, more preferably 4.0 mol % or more.

On the other hand, if the aluminum content is too high, it may affect the appearance of the multilayer ceramic capacitor 100. Therefore, it is preferable to set an upper limit on the aluminum content in the section 60. In this embodiment, when the titanium content of barium titanate in the section 60 is 100 mol %, the aluminum content in the section 60 is preferably 10.0 mol % or less, more preferably 8.0 mol % or less, and even more preferably 5.0 mol % or less.

Next, to sufficiently retain the aluminum-containing borosilicate glass in the section 60, it is preferable to set the aluminum concentration in the section 60 higher than that of the dielectric layer 11 of the capacity section 14. In this embodiment, the aluminum concentration in the section 60 is preferably higher than that of the dielectric layer 11 of the capacity section 14, more preferably by 1.0 mol % or more, and even more preferably by 2.0 mol % or more.

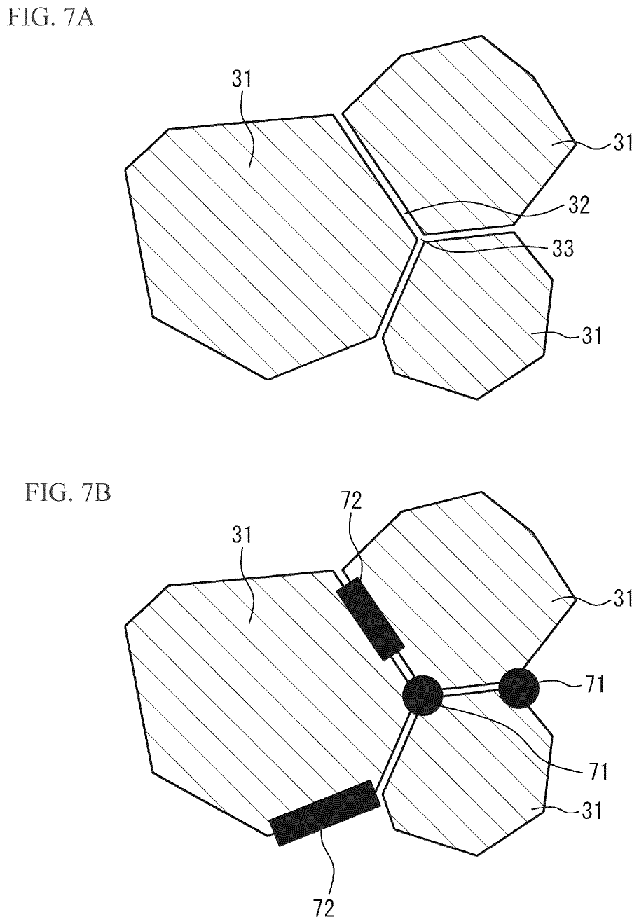

As illustrated in FIG. 7A, the section 60 has a structure in which multiple dielectric grains 31 are sintered. Therefore, a grain boundary 32 and a grain boundary triple point 33 are formed between the multiple dielectric grains 31. The silicon, boron, and aluminum contained in the section 60 are preferably present as amorphous borosilicate glass at the grain boundary 32 or the grain boundary triple point 33.

For example, as illustrated in FIG. 7B, borosilicate glass preferably exists as a particulate segregate 71 or a needle-shaped segregate 72 at the grain boundary 32 or the grain boundary triple point 33 in FIG. 7A. Here, the particulate segregate 71 refers to a segregate that has a roughly circular cross section. The needle-shaped segregate 72 refers to a segregate that has a shape, such as a rectangular shape, with the major and minor axes clearly visible in the cross section, with the major axis being at least three times the minor axis.

From the perspective of mitigating post-sintering residual stress (stress resulting from the difference in thermal expansion coefficients between the electrode metal and ceramic), the average grain size of the dielectric grains 31 contained in the section 60 is preferably greater than twice, more preferably at least 2.5 times, and even more preferably at least 3.0 times, the average grain size of the dielectric grains contained in the dielectric layer 11 of the capacity section 14. Note that the dielectric layer 11 of the capacity section 14 also has a structure in which multiple dielectric grains are sintered, as described in FIG. 7A. The average grain size of the dielectric grains 31 contained in the section 60 and the average grain size of the dielectric grains contained in the dielectric layer 11 of the capacity section 14 can be measured by using image analysis software to calculate the ferret diameter of an image of a mirror-polished device cross section taken with a scanning electron microscope (SEM).

Note that the side margin 16 tends to have a lower density than the cover layer 13, resulting in delayed sintering. This is because the side margin in the same plane as the internal electrode layer is not printed with the internal electrode layer, resulting in a void. Therefore, when the entire outer periphery 30 is the section 60, it is preferable that the aluminum concentration of the cover layer 13 and the side margin 16 is different, and the aluminum concentration of the side margin 16 be higher than that of the cover layer 13. In this embodiment, the aluminum concentration of the cover layer 13 is preferably at least 0.5 mol % higher than that of the side margin 16, more preferably at least 1.5 mol % higher, and even more preferably at least 2.0 mol % higher.

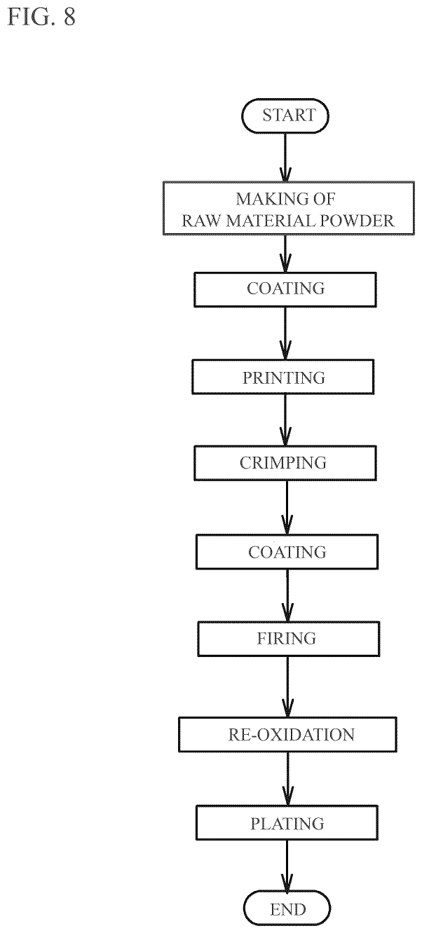

Next, a description will be given of a manufacturing method of the multilayer ceramic capacitors 100. FIG. 8 illustrates a manufacturing method of the multilayer ceramic capacitor 100.

(Making process of raw material powder) First, a dielectric material for forming the dielectric layer 11, a cover material for forming the cover layer 13, and a reverse pattern material for forming the side margin 16 are prepared. The dielectric material, the cover material, and the reverse pattern material contain barium titanate powder having a perovskite structure. For example, barium titanate is tetragonal compound having a perovskite structure and has a high dielectric constant. Generally, barium titanate is obtained by reacting a titanium material such as titanium dioxide with a barium material such as barium carbonate and synthesizing barium titanate.

The obtained barium titanate powder is added with a predetermined additive compound depending on the purpose to produce the dielectric material, the cover material, and the reverse pattern material, respectively. As the additive compound, zirconium, hafnium, magnesium, manganese, molybdenum, vanadium, chromium, rare earth elements (yttrium, samarium, europium, gadolinium, terbium, dysprosium, holmium, erbium, thulium, and ytterbium) or an oxide of cobalt, nickel, lithium, boron, sodium, potassium or silicon, or a glass including cobalt, nickel, lithium, boron, sodium, potassium or silicon.

The amounts of additive compounds of the dielectric material, the cover material, and the reverse pattern material are adjusted so that the section 60 obtained after the firing process described below contains 0.1 mol % or more of boron, 1.0 mol % or more of silicon, and 1.0 mol % or more of aluminum, when the titanium in barium titanate is taken as 100 mol %, with less than 0.1 mol % of magnesium and less than 0.1 mol % of manganese, and the aluminum concentration is equal to or greater than the aluminum concentration in the dielectric layer 11 of the capacity section 14. As will be described later, the dielectric material also forms part of the side margin 16.

(Coating process) Next, a binder such as polyvinyl butyral (PVB) resin, an organic solvent such as ethanol or toluene, and a plasticizer are added to the obtained dielectric material and wet-mixed. Using the obtained slurry, a dielectric green sheet 51 is formed on the substrate by, for example, a die coater method or a doctor blade method, and dried. The substrate is, for example, polyethylene terephthalate (PET) film.

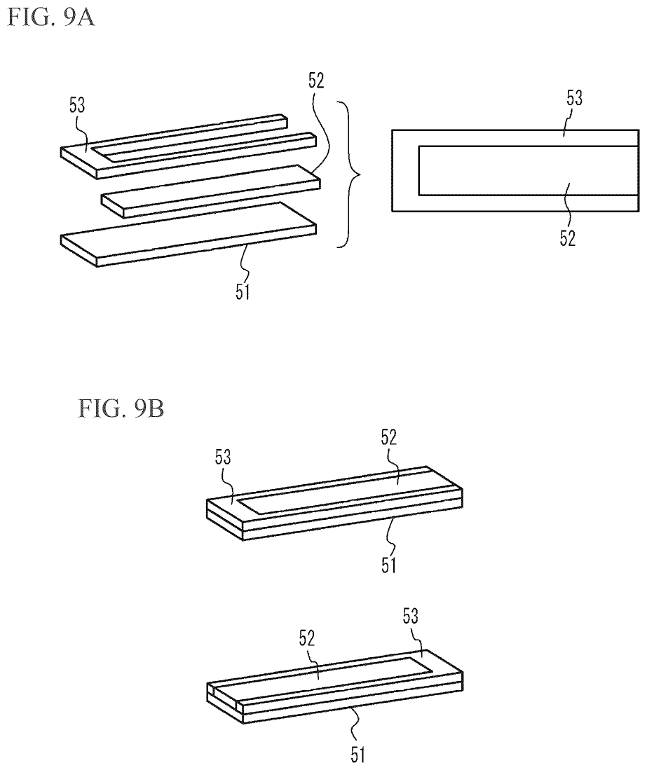

(Printing process) Next, as illustrated in FIG. 9A, a metal conductive paste for forming internal electrodes containing an organic binder is printed on the surface of the dielectric green sheet 51 by screen printing, gravure printing, or the like to form internal electrodes. Thus, an internal electrode pattern 52 for layers is arranged. Ceramic particles may be added to the metal conductive paste as a co-material. The main component of the ceramic particles is not limited. However, it is preferable that the main component of the ceramic particles is the same as the main component of the dielectric layer 11. For example, barium titanate having an average particle size of 50 nm or less may be uniformly dispersed.

Next, a binder such as ethyl cellulose and an organic solvent such as terpineol are added to the dielectric pattern material obtained in the making process of the raw material powder, and the mixture is kneaded in a roll mill to form a dielectric pattern paste for the reverse pattern layer. As illustrated in FIG. 9A, a dielectric pattern 53 is formed by printing the resulting slurry in the peripheral region, where the internal electrode pattern 52 is not printed, on the dielectric green sheet 51 to cause the dielectric pattern 53 and the internal electrode pattern 52 to form a flat surface. The dielectric green sheet 51 on which the internal electrode pattern 52 and the dielectric pattern 53 are printed is referred to as a stack unit.

Thereafter, as illustrated in FIG. 9B, a predetermined number of stack units are stacked so that the internal electrode layers 12 and the dielectric layers 11 are alternated with each other and the end edges of the internal electrode layers 12 are alternately exposed to both end faces in the length direction of the dielectric layer 11 so as to be alternately led out to a pair of the external electrodes 20a and 20b of different polarizations. In this embodiment, the number of the internal electrode pattern 52 is 100 to 1000.

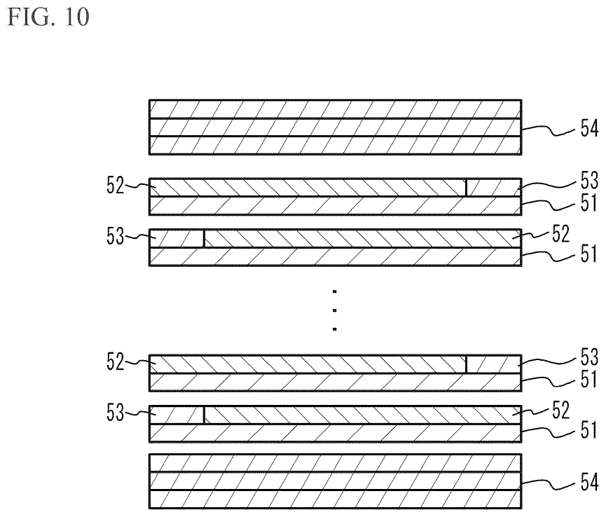

(Crimping process) Next, a binder such as an ethyl cellulose-based binder and an organic solvent such as a terpineol-based binder are added to the cover material and kneaded in a roll mill to obtain a cover sheet 54. As illustrated in FIG. 10, a predetermined number of the cover sheets 54 are stacked on top and bottom of a multilayer body in which the stack units are stacked, and then thermocompression bonded. The stack body is then cut to a predetermined chip size (for example, 1.0 mm×0.5 mm).

(Coating process) The binder is removed from the resulting ceramic multilayer body in N₂ atmosphere, normal atmosphere or the like. After that, a metal paste to be the base layer of the external electrodes 20a and 20b is applied to the resulting ceramic multilayer body by a dipping or the like.

(Firing process) A firing is performed for 10 minutes to 2 hours in a reducing atmosphere with an oxygen partial pressure of 10⁻¹⁰ to 10⁻⁷ atm in a temperature of 1100° C. to 1300° C.

(Re-oxidation process) Thereafter, a re-oxidation process may be performed in an N₂ gas atmosphere at 600 to 1000° C.

(Plating process) After that, metal layers such as copper, nickel, and tin may be formed on the external electrodes 20a and 20b by plating. Thus, the multilayer ceramic capacitor 100 is manufactured.

Note that in each of the above embodiments, a multilayer ceramic capacitor has been described as an example of a multilayer ceramic electronic device, but the present invention is not limited thereto. For example, other multilayer ceramic electronic devices such as varistors and thermistors may be used.

### EXAMPLE

The multilayer ceramic capacitors according to the above embodiment were fabricated and their characteristics were examined.

(Comparative Example 1) Barium titanate with an average particle size of 100 nm, prepared by solid-phase synthesis, was used as the main phase. B₂O₃ was weighed out to 0.5 mol % (1.0 mol % as B element), SiO₂ to 2.0 mol %, BaCO₃ to 1.0 mol %, and Ho₂O₃ to 0.5 mol % (1.0 mol % as Ho element). This mixed powder was dispersed in zirconia beads along with ethanol, toluene, and a dispersant. Dispersion was stopped when the median particle size of the barium titanate particle size distribution reached 100 nm. After dispersion, the slurry was passed through a filter to separate the zirconia beads. PVB (polyvinyl butyral) resin was then mixed in as a binder to prepare a dielectric slurry for the capacity section.

The resulting slurry was then applied to a PET film using a die coater to form a 4.0 μm-thick dielectric green sheet. After drying, the dielectric green sheets were printed with nickel paste to form internal electrode patterns. 101 layers of dielectric green sheets with printed internal electrode patterns were stacked. The positive and negative electrode patterns were alternately stacked. 50 μm thick dielectric layers of the same composition were stacked on top and bottom as protective layers and thermocompression bonded. The resulting plate-shaped compact was sintered and then cut into individual chips measuring 1.0 mm×0.5 mm. Nickel paste was dipped into the two opposing surfaces of the cut chips, where the internal electrode leads were exposed, to form terminal electrodes.

The resulting chips were heated to 800° C. at 100° C./h in a reducing atmosphere using a N₂—H₂-H₂O mixed gas, and then de-bindered. The heating rate was then increased to 6000° C./h, the temperature was raised to 1250° C., held for 1 minute, and then cooled to room temperature. The sintered chip was then re-oxidized at 800° C. in a dry N₂ atmosphere. This resulted in a multilayer ceramic capacitor (Comparative Example 1) with a total of 100 effective dielectrics. The average dielectric thickness of each layer after sintering was 3.2 μm. This multilayer ceramic capacitor did not contain aluminum in either the capacity section or the cover layer.

(Comparative Example 2) In Comparative Example 2, the cover layer contained 0.5 mol % aluminum relative to 100 mol % titanium in barium titanate. Fine Al₂O₃ powder (<50 nm) was used to ensure sufficient dissolution of the aluminum into the borosilicate glass. Therefore, the amount of Al₂O₃ added was half the aluminum element concentration. Therefore, the Al₂O₃ concentration in Comparative Example 2 was 0.25 mol %. All other conditions were the same as in Comparative Example 1.

(Examples 1-4) Multilayer ceramic capacitors were fabricated using the same method as in Comparative Examples 1 and 2, with varying amounts of aluminum added to the cover layer. In the cover layer, the aluminum content was 1.0 mol % in Example 1, 5.0 mol % in Example 2, 10.0 mol % in Example 3, and 15.0 mol % in Example 4, assuming 100 mol % titanium in barium titanate. Other conditions were the same as in Comparative Example 1. In these Examples, no aluminum was added to the capacity section, so in all cases the aluminum concentration in the dielectric layer of the capacity section was less than the aluminum concentration in the cover layer, and the aluminum content in the cover layer was 1.0 mol % or greater.

(Moisture Resistance Test and High-Temperature Accelerated Life Test) After re-oxidation, the multilayer ceramic capacitors of Comparative Examples 1 and 2 and Examples 1 to 4 were reflow soldered onto a printed circuit board with a parallel circuit and connected to a stabilized power supply. They were then placed in a humidity-controlled thermostatic chamber and a DC voltage was applied. The humidity resistance test was conducted at 40° C., 90-95% RH, and 100V for 500 hours on 1,000 test pieces. The failure rate after 500 hours was expressed as a percentage. Only samples with a 0% failure rate under these conditions were considered pass; all others were considered fail. The high-temperature accelerated life test was conducted in a 125° C. thermostatic chamber at 100V on 100 test pieces. The life was defined as the time when all samples reached a short circuit or the resistance value dropped to 1/1,000 of the value at the start of the test. The time was automatically recorded for each test, and the average was used as the average life value. Under these conditions, a mean life of more than 48 hours was considered pass; a mean life of less than 48 hours was considered fail. A sample that passed both the humidity resistance test and the high-temperature accelerated life test was considered pass overall; a sample that failed either test was considered fail.

(Evaluation Results) Both Comparative Examples 1 and 2 failed the humidity resistance test. This is thought to be because no aluminum was added or the amount was too small, preventing the borosilicate glass from thoroughly wetting the sintered body of the cover layer to densify the cover layer. In contrast, all of Examples 1 to 4 passed the humidity resistance test. This is thought to be because the cover layer contained 0.1 mol % or more of boron, 1.0 mol % or more of silicon, and 1.0 mol % or more of aluminum, and the aluminum concentration was equal to or greater than the aluminum concentration in the dielectric layer of the capacity section. Furthermore, all of Examples 1 to 4 also passed the high-temperature accelerated life test, with no problems. This is thought to be because the cover layer contained less than 0.1 mol % of magnesium and less than 0.1 mol % of manganese. Thus, Examples 1 to 4 achieved surprisingly good results not achieved in Comparative Examples 1 and 2.

In Example 4, in which the aluminum content was increased to 15 mol %, there were no problems with the electrical characteristics, but noticeable glass-like stains were observed on the surface of the multilayer ceramic capacitor. In such cases, the actual product may have poor appearance. Therefore, it was found that it is preferable to limit the aluminum content in the cover layer to 10 mol % or less.

(Example 5) In Example 5, the aluminum content in the cover layer was adjusted to 1.0 mol % when the titanium content of the barium titanate was 100 mol %. Furthermore, the aluminum content in the dielectric layer of the capacity section was adjusted to 1.0 mol % when the titanium content of the barium titanate was 100 mol %. In other words, the aluminum concentration in the cover layer was matched to that of the dielectric layer of the capacity section. Other conditions were the same as in Comparative Example 1.

(Comparative Example 3) In Comparative Example 3, the aluminum content in the cover layer was adjusted to 1.0 mol % when the titanium content of the barium titanate was 100 mol %. In the dielectric layer of the capacity section, the aluminum content was 2.0 mol % when the titanium content of the barium titanate was 100 mol %. In other words, the aluminum concentration in the dielectric layer of the capacity section was higher than that in the outer periphery. Other conditions were the same as in Comparative Example 1.

(Comparative Example 4) In Comparative Example 4, the aluminum content in the cover layer was 1.0 mol % when the titanium content of the barium titanate was 100 mol %. In the dielectric layer of the capacity section, the aluminum content was 3.0 mol % when the titanium content of the barium titanate was 100 mol %. In other words, the aluminum concentration in the dielectric layer of the capacity section was higher than that in the outer periphery. Other conditions were the same as in Comparative Example 1.

Both Comparative Examples 3 and 4 failed the high-temperature accelerated life test. This is thought to be because in Comparative Example 3, even though the burning of the cover layer was stopped at the appropriate time, the internal electrode layer was interrupted and began to spheroidize. This is thought to be because grain growth occurred in the dielectric layer of the capacity section in Comparative Example 4. In contrast, Example 5 passed both the humidity resistance test and the high-temperature accelerated life test. This is thought to be because the cover layer contained 0.1 mol % or more of boron, 1.0 mol % or more of silicon, and 1.0 mol % or more of aluminum, less than 0.1 mol % of magnesium, less than 0.1 mol % of manganese, and the aluminum concentration was equivalent to the aluminum concentration in the dielectric layer of the capacity section. Thus, Example 5 achieved surprisingly good results not obtained in Comparative Examples 3 and 4.

(Comparative Examples 5 and 6) In Comparative Example 5, no silicon was added to the cover layer. In Comparative Example 6, the cover layer had a silicon concentration of 0.5 mol % when the titanium content of the barium titanate was 100 mol %. Other conditions were the same as in Comparative Example 1.

(Examples 6-8) In Example 6, the cover layer had a silicon concentration of 1.0 mol % when the titanium content of the barium titanate was 100 mol %. In Example 7, the cover layer had a silicon concentration of 3.0 mol % when the titanium content of the barium titanate was 100 mol %. In Example 8, the cover layer had a silicon concentration of 4.0 mol % when the titanium content of the barium titanate was 100 mol %. Other conditions were the same as in Comparative Example 1.

Both Comparative Examples 5 and 6 failed the humidity resistance test. This is thought to be because the silicon concentration in the cover layer was less than 1.0 mol %. In contrast, all of Examples 6 to 8 passed both the humidity resistance test and the high-temperature accelerated life test. This is thought to be because the cover layer contained 0.1 mol % or more of boron, 1.0 mol % or more of silicon, and 1.0 mol % or more of aluminum, with magnesium less than 0.1 mol % and manganese less than 0.1 mol %, and the aluminum concentration was equal to or greater than the aluminum concentration in the dielectric layer of the capacity section. Thus, Examples 6 to 8 achieved surprisingly good results not achieved in Comparative Examples 5 and 6.

In Example 8, in which the silicon content was increased to 4.0 mol %, there were no problems with the electrical characteristics, but the multilayer ceramic capacitor exhibited noticeable glass-like stains on the surface. In such cases, the appearance of the actual product may be poor. Therefore, it was found that it is preferable to limit the silicon content in the cover layer to 3.0 mol % or less.

(Comparative Example 7) In Comparative Example 7, boron was not added to the cover layer. All other conditions were the same as in Comparative Example 1.

(Examples 9-11) In Example 9, the cover layer had a boron concentration of 0.1 mol % when the titanium content of the barium titanate was 100 mol %. In Example 10, the cover layer had a boron concentration of 2.5 mol % when the titanium content of the barium titanate was 100 mol %. In Example 11, the cover layer had a silicon concentration of 5.0 mol % when the titanium content of the barium titanate was 100 mol %. All other conditions were the same as in Comparative Example 1.

In Comparative Example 7, the humidity resistance test failed. This is believed to be due to the boron concentration in the cover layer being less than 0.1 mol %. In contrast, all of Examples 9-11 passed both the humidity resistance test and the high-temperature accelerated life test. This is thought to be because the cover layer contained 0.1 mol % or more boron, 1.0 mol % or more silicon, and 1.0 mol % or more aluminum, less than 0.1 mol % magnesium, less than 0.1 mol % manganese, and an aluminum concentration equal to or greater than that of the dielectric layer of the capacity section. Thus, Examples 9 to 11 achieved surprisingly good results not achieved in Comparative Example 7.

Note that, as in Example 9, the humidity resistance test passed even with a boron concentration of 0.1 mol %. Comparing Examples 9, 1, 10, and 11, the high-temperature accelerated life was locally maximized at boron concentrations between 1 mol % and 2.5 mol %, suggesting that a boron concentration of around 1 mol % is preferable. Furthermore, in Example 11, in which the boron content was increased to 5.0 mol %, there were no problems with the electrical characteristics, but noticeable glass-like stains were observed on the surface of the multilayer ceramic capacitor. In such cases, the actual product may exhibit poor appearance. Therefore, it was found that it is preferable to limit the amount of boron added to the cover layer to 2.5 mol % or less.

These results are shown in Table 1. Note that while Examples 1 to 11 focus on the cover layer, the side margin also forms part of the outer periphery, so even if similar experiments were conducted on the side margin, it is believed that the moisture resistance test and accelerated life test A would pass as long as the side margin contains 0.1 mol % or more of boron, 1.0 mol % or more of silicon, and 1.0 mol % or more of aluminum, with magnesium less than 0.1 mol % and manganese less than 0.1 mol %, and the aluminum concentration is equal to or greater than the aluminum concentration in the dielectric layer of the capacity section.

TABLE 1

| | | | | CAPASITY | HUMIDITY | |
|---|---|---|---|---|---|---|
| | COVER LAYER | | | SECTION | RESISTANCE | |
| | BORON | SILICON | ALUMINUM | ALUMINUM | TEST | MEAN |
| | AMOUNT | AMOUNT | AMOUNT | AMOUNT | FAILURE | LIFE |
| | (mol %) | (mol %) | (mol %) | (mol %) | RATE (%) | (h) |
| COMPARATIVE | 1.0 | 2.0 | 0.0 | 0.0 | 37 | 62 |
| EXAMPLE 1 | | | | | | |
| COMPARATIVE | 1.0 | 2.0 | 0.5 | 0.0 | 15 | 70 |
| EXAMPLE 2 | | | | | | |
| EXAMPLE 1 | 1.0 | 2.0 | 1.0 | 0.0 | 0 | 108 |
| EXAMPLE 2 | 1.0 | 2.0 | 5.0 | 0.0 | 0 | 76 |
| EXAMPLE 3 | 1.0 | 2.0 | 10.0 | 0.0 | 0 | 80 |
| EXAMPLE 4 | 1.0 | 2.0 | 15.0 | 0.0 | 0 | 82 |
| EXAMPLE 5 | 1.0 | 2.0 | 1.0 | 1.0 | 0 | 64 |
| COMPARATIVE | 1.0 | 2.0 | 1.0 | 2.0 | 0 | 28 |
| EXAMPLE 3 | | | | | | |
| COMPARATIVE | 1.0 | 2.0 | 1.0 | 3.0 | 0 | 4 |
| EXAMPLE 4 | | | | | | |
| COMPARATIVE | 1.0 | 0.0 | 1.0 | 3.0 | 9 | 96 |
| EXAMPLE 5 | | | | | | |
| COMPARATIVE | 1.0 | 0.5 | 1.0 | 0.0 | 3 | 88 |
| EXAMPLE 6 | | | | | | |
| EXAMPLE 6 | 1.0 | 1.0 | 1.0 | 0.0 | 0 | 112 |
| EXAMPLE 7 | 1.0 | 3.0 | 1.0 | 0.0 | 0 | 106 |
| EXAMPLE 8 | 1.0 | 4.0 | 1.0 | 0.0 | 0 | 92 |
| COMPARATIVE | 0.0 | 2.0 | 1.0 | 0.0 | 96 | 1 |
| EXAMPLE 7 | | | | | | |
| EXAMPLE 9 | 0.1 | 2.0 | 1.0 | 0.0 | 0 | 72 |
| EXAMPLE 10 | 2.5 | 2.0 | 1.0 | 0.0 | 0 | 97 |
| EXAMPLE 11 | 5.0 | 2.0 | 1.0 | 0.0 | 0 | 92 |

Although the embodiments of the present invention have been described in detail, it is to be understood that the various change, substitutions, and alterations could be made hereto without departing from the spirit and scope of the invention.

1. A multilayer ceramic electronic device comprising:
a dielectric layer;
internal electrode layers facing each other with the dielectric layer therebetween;
a cover layer provided outside an outermost one of the internal electrode layers in a first direction which is a stacking direction of the dielectric layer and the internal electrode layers;
a side margin provided adjacent to the dielectric layer and the internal electrode layers in a second direction orthogonal to the first direction; and
an external electrode provided adjacent to the internal electrode layers in a third direction orthogonal to the first direction and the second direction and electrically connected to the internal electrode layers,
wherein at least a section of an outer periphery consisting of the cover layer and the side margin contains barium titanate as a main component, and when an amount of titanium of the barium titanate is taken as 100 mol %, the section contains 0.1 mol % or more of boron, 1.0 mol % or more of silicon, and 1.0 mol % or more of aluminum, with less than 0.1 mol % of magnesium and less than 0.1 mol % of manganese, and an aluminum concentration of the section is equal to or greater than that of the dielectric layer.

2. The multilayer ceramic electronic device as claimed in claim 1,
wherein in the section, a concentration of boron is 2.5 mol % or less when the amount of titanium of the barium titanate is 100 mol %.

3. The multilayer ceramic electronic device as claimed in claim 1,
wherein in the section, a concentration of silicon is 3.0 mol % or less when the amount of titanium of the barium titanate is 100 mol %.

4. The multilayer ceramic electronic device as claimed in claim 1,
wherein in the section, a concentration of aluminum is 10.0 mol % or less when the amount of titanium of the barium titanate is 100 mol %.

5. The multilayer ceramic electronic device as claimed in claim 1,
wherein the section contains dielectric grains, and
wherein silicon and aluminum are present at a grain boundary and a grain boundary triple junction of the dielectric grains as an amorphous phase or a needle-like segregate.

6. The multilayer ceramic electronic device as claimed in claim 1,
wherein an aluminum concentration differs between the cover layer and the side margin, and
wherein the aluminum concentration of the side margin is higher than that of the cover layer.

7. The multilayer ceramic electronic device as claimed in claim 1,
wherein an average grain size of dielectric grains contained in the cover layer or the side margin is greater than twice an average grain size of dielectric grains contained in the dielectric layer.
